(19) United States
(12) Patent Application Publication
(10) Pub. No.: US 2005/0234789 A1
(43) Pub. Date: Oct. 20, 2005

(54) Systems, methods and computer readable media for providing and managing balance transfer accounts

(76) Inventors: Nathan Tad Czyzewski, Arlington, VA (US); Franco Dokmanovora Harris, Sewickley, PA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/823,540

(22) Filed: Apr. 14, 2004

(51) Int. Cl. G06F 17/60; G06F 17/00

(52) U.S. Cl. 705/35; 707/100

(57) ABSTRACT

Systems, methods and computer readable media provide mechanisms to manage a financial account including a credit line sub-account for managing purchases by the customer and a balance transfer sub-account for managing at least one balance transferred by the customer. Attributes of the balance transfer sub-account define a structured repayment plan. These attributes may include a maximum required periodic payment and a maximum interest rate that are fixed for the life of the balance. The maximum periodic payment may be a fixed amount. These attributes may also include a pay-off date for the balance transfer sub-account. The pay-off date may be customized for the customer. The account may lack minimum purchase requirements on the credit line sub-account. The issuer may lack the ability to reprice the balance transfer sub-account if the customer breaks a rule. The financial account may be a credit card account.

### TECHNICAL FIELD

The present invention relates generally to financial accounts and, more particularly, to the provision and management of financial accounts having both a credit line sub-account and a balance transfer sub-account.

### BACKGROUND

Consumers carry a variety of debt. Examples of such debt include debt on conventional loans (e.g., installment loans such as personal loans, auto loans, student loans, home improvement loans, etc.) and debt on credit line accounts.

Conventional loans provide a mechanism by which a borrower may spread payment of a major expense, such as the purchase of a car or the payment of tuition, over a period of time, sometimes years. Such loans are typically subject to a pre-set payment schedule. The borrower must pay off the loan principle with interest by a fixed date or be in default on the loan.

Credit line accounts provide a mechanism by which an authorized credit-holder may purchase goods or services without an immediate, direct exchange of cash. An example of such an account is the familiar credit card account. With each purchase, a cardholder incurs debt to the credit card issuer which he or she may thereafter (i.e., upon receipt the next account statement) fully pay or, as a matter of necessity or choice, defer at least a portion of the balance for later payment with accompanying interest or finance charges for the period during which payment of the outstanding debt is deferred. Unlike conventional loans, credit card debt need not be paid off by a fixed date. So long as the cardholder continues to make the minimum periodic payment, usually consisting of little more than the interest on the balance, their account will remain in good standing with the issuer.

To attract new customers, a credit card issuer may offer a balance transfer sub-account in addition to a credit line sub-account within a single credit card account. With such an offer, the prospective cardholder is given the option of transferring an outstanding debt owed on another credit card account to a balance transfer sub-account with the issuer. A fee may be charged for transferring the balance; however, as an incentive for the prospective cardholder to open a credit card account, the balance transfer sub-account may offer other favorable terms, such as an extended initial grace period during which the cardholder may pay off the transferred balance without incurring interest charges.

Once a balance is transferred, the issuer pays off the debt on the cardholder's original credit card account and, after expiration of the initial grace period (if any), charges the cardholder interest on the transferred balance. When the cardholder makes payments to the issuer, the payments are split between the credit line and balance transfer sub-accounts by a predetermined arrangement, e.g., in proportion to the balances on the respective accounts.

The combination of a credit line sub-account with a balance transfer sub-account is attractive to both cardholders and credit card issuers. The cardholder obtains more favorable terms on their transferred debt as well as the convenience of making one payment on both their credit line and balance transfer accounts. The credit card issuer receives income from fees and/or interest charged to the customer on the balances of the credit line and balance transfer sub-accounts, as well as from fees charged to the vendors where the customer makes their purchases. Further, because the issuer's management costs are spread over the two sub-accounts, the credit card issuer may be able to administer the balance transfer sub-account more profitably than a conventional lender could administer a conventional loan.

Because it is expensive to solicit prospective cardholders, credit card issuers could realize more profits if their credit card accounts were more attractive to prospective cardholders, thereby increasing the ratio of accounts opened per solicitation. Because it is also expensive to manage an account once opened, credit card issuers could realize more profits if their cardholders would make larger purchases using the credit line sub-account and transfer larger balances, e.g., from conventional loans, to the balance transfer sub-account, thereby increasing fee and/or interest income to the issuer per account.

However, conventional loans have the advantage of providing customers with a structured repayment plan whereby the customer knows the minimum monthly payment, interest rate, and pay-off date for the loan principal in advance of accepting the loan. Conventional balance transfer sub-accounts are not structured to provide the customer with such certainty. Although the interest rate and a formula for calculating the minimum monthly payment may be provided to the customer by the issuer, the pay-off date is not. Further, in conventional balance transfer sub-accounts, the issuer reserves the right to reprice the balance transfer sub-account (i.e., raise the interest rate), and thus allocate a smaller percentage of the payment toward the balance principal, if market rates rise or if the customer fails to meet a condition of the account agreement (e.g., makes a late payment). Therefore, customers are unsure when the transferred balance would be paid off, and prospective cardholders may fear that the that debt will become a static debt on which the customer will be perpetually required to pay interest. Consequently, customers may be unwilling to transfer larger balances to balance transfer sub-accounts, and solicitations offering the opportunity to transfer balances may receive less than optimal response.

Further, some customers have not found the combination of attributes in both of the credit line and balance transfer sub-accounts of conventional credit card accounts to be attractive. Credit card accounts offering attractive terms with respect to the credit line sub-account offer less attractive terms with respect to the balance transfer sub-account, and vice versa. Consequently, some customers maintain one credit card account for their purchases and another credit card account for their balance transfers, often with different issuers. Further, the issuers of each of these dual credit card accounts maintained by the customer expend resources managing a sub-account which the customer does not use, and which therefore provides no income to the issuer. Thus, neither customers nor issuers achieve the benefits and efficiencies possible when a single credit card issuer manages both a customer's credit line sub-account and balance transfer sub-account.

Accordingly, there is a need for improved systems, methods and computer readable media for providing and managing financial accounts having both credit line and balance transfer sub-accounts wherein cardholders are provided with an attractive combination of terms for the two sub-accounts and with greater certainty that they will pay off their transferred balances in a certain period of time.

### SUMMARY

Systems, methods and computer readable media consistent with the present invention address these and other needs by providing mechanisms to manage a financial account including a credit line sub-account for managing purchases by the customer and a balance transfer sub-account for managing at least one balance transferred by the customer. Attributes of the balance transfer sub-account define a structured repayment plan. These attributes may include a maximum required periodic payment and a maximum interest rate that are fixed for the life of the balance. The maximum periodic payment may be a fixed amount. The maximum interest rate may be 0% and an initiation fee that is based upon the size of the transferred balance may be defined for the balance transfer sub-account. These attributes may also include a pay-off date for the balance transfer sub-account. The pay-off date may be customized for the customer. The account may lack minimum purchase requirements on the credit line sub-account. The issuer may lack the ability to reprice the balance transfer sub-account if the customer breaks a rule. The financial account may be a credit card account.

It is to be understood that both the foregoing general summary and the following detailed description are exemplary and explanatory only and are not restrictive of the invention, as claimed. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, illustrate various embodiments of the present invention and, together with the description, serve to explain the principles of the invention. In the drawings:

FIG. 1 is a schematic illustration of an exemplary system environment 100 consistent with the present invention; and

FIG. 2 is a flow chart that illustrates exemplary methods for providing and managing financial accounts consistent with the present invention.

### DETAILED DESCRIPTION

Systems, methods and computer readable media consistent with the present invention provide the customer with greater certainty that they will pay off a balance transferred to a balance transfer sub-account offered by an issuer. Consequently, systems, methods and computer readable media consistent with the present invention provide an incentive for customers to open a financial account offered by an issuer, to transfer a larger balance to a balance transfer sub-account within the financial account, and to make larger purchases using a credit line sub-account within the financial account, thereby improving cardholder satisfaction with the as well as issuer profitability.

For simplicity, exemplary financial accounts of the present invention are described as including a single credit line sub-account and a single balance transfer sub-account. However, those of skill in the art will recognize that a single financial account may include a plurality of credit line sub-accounts and/or a plurality of balance transfer sub-accounts. Further, the credit line sub-account may be further divided into separate sub-accounts for credit purchases and cash advances, with each of these sub-accounts having distinct attributes.

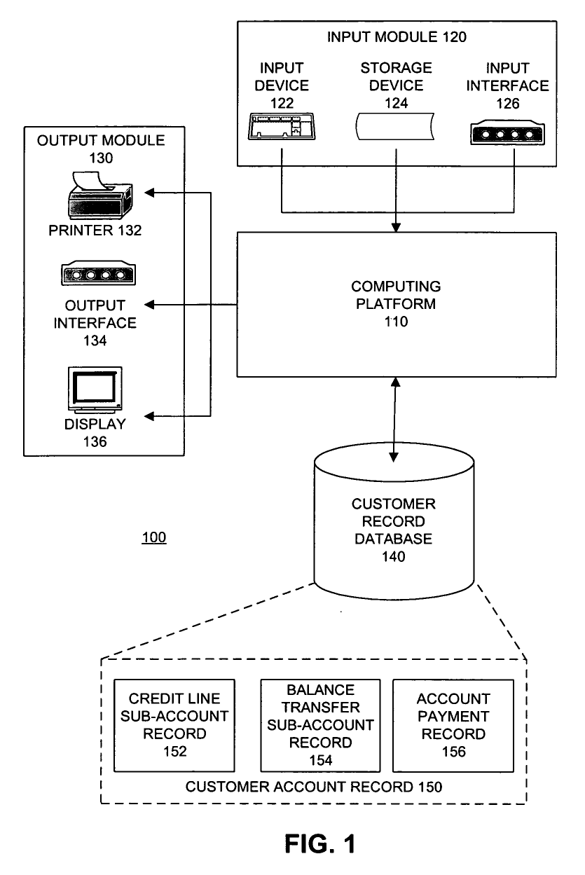

FIG. 1 illustrates an exemplary system environment 100 consistent with the present invention. As illustrated in FIG. 1, system 100 includes a computing platform 110, an input module 120, an output module 130, and a customer record database 140.

Computing platform 110 is adapted to process input information received from input module 120. Computing platform 110 is further adapted to provide output information to output module 130. Additionally, computing platform 110 is adapted to access information in customer record database 140 for use in performing methods consistent with the present invention (discussed below).

Computing platform 110 preferably comprises a general purpose computer (e.g., a personal computer, network computer, server, or mainframe computer) having a processor that may be selectively activated or reconfigured by a computer program to perform one or more methods consistent with the present invention. Computing platform 110 may also be implemented in a distributed network. Alternatively, computing platform 110 may be specially constructed for carrying-out methods consistent with the present invention.

Input module 120 may include an input device 122, a storage device 124, and/or an input interface 126. Input device 122 may be implemented using a keyboard, mouse, speech recognition device, or other user interface adapted for data entry. Storage device 124 may include a memory, such as RAM or ROM memory that contains instructions or data for performing one or more methods consistent with the present invention. Computing platform 110 may link storage device 124 to input interface 126. Input interface may in turn be linked to a device (not shown), such as a disk drive or the Internet, for transferring instructions from a computer readable medium to the storage device 124 for later execution by the computing platform 110.

Consistent with the present invention, a computer readable medium is any type of medium that is capable of carrying information that may be used to configure computing platform 110 to perform methods consistent with the present invention. Computer readable medium may be, for example, a physical media (e.g., a punch card), a magnetic media (e.g., a magnetic disk or tape), an optical media (e.g., an optical disk), or a carrier wave (e.g., from a computer network, such as the Internet). Computer readable medium may be encoded with instructions for configuring the computing platform to perform one or more methods consistent with the present invention. Computer readable medium may also contain data used in such methods.

In creating a new account, input module 120 may be used to enter or obtain information about a customer and/or, attributes of the customer's accounts. This information may be obtained, for example, from the customer, from storage device 124, or from a computer readable media, such as a disk drive or carrier wave, via input interface 126. After a new account has been created, input module 120 may be used to enter or obtain information about transactions made by the customer using the account. Computing platform 110 may then store the information received fro input module 120 in customer record database 140.

As described below, computing platform 110 uses the stored account information to manage the customer's account using methods consistent with the present invention. Computing module 110 also provides account information generated by computing module 110 or obtained from customer record database 140 to output module 130. Output module 130 in turn outputs the received information to the customer or to customer service representatives for use internally or for assisting the customer.

Output module 130 may include a printer 132, an output interface 134, and/or a display 136. Printer 132 may be used to provide a conventional billing statement to the customer. Output interface 134 may provide billing and other information to the customer via the Internet in the form of an online account statement, or save the information on a computer readable medium. Display 136 may provide account information to customer service representatives who may assist the customer via telephone.

Customer record database 140 may be used to store customer account records 150. Customer account records 150 preferably include the customer's identifying information, such as the customer's name, billing address, telephone number, and/or Social Security number, etc. Customer account records 150 may also include other information about the customer, such as the customer's credit rating, credit history, and/or demographic information.

Customer account records 150 preferably also include: a credit line sub-account record 152; a balance transfer sub-account record 154; and an account payment record 156. The information contained in these records corresponds to information contained in an account agreement between the customer and the issuer that governs the terms of the account. These records also contain information corresponding to transactions made by the customer using the account. The information to be entered in records 150, 152, 154 and 156 may be entered or obtained using input module 120.

Credit line sub-account record 152 may store information related to the attributes of the credit line sub-account, such as: the credit limit; the grace period on purchases; minimum credit line purchase requirements; the interest rate on the credit line sub-account; the minimum payment on the credit line sub-account; conditions for modification of the credit-line sub-account attributes; and information on rewards, e.g., cash back, used to encourage purchases using the credit line sub-account. Credit line sub-account record may also store information regarding credit line transactions, such as: the amount of the customer's last payment; the date of the customer's last payment; the amount charged by the customer; and the provider of goods or services to whom the charge was made; the current credit line balance; and the amount of credit currently available to the customer.

Balance transfer sub-account record 154 may store information related to the attributes of the balance transfer sub-account, such as: the balance limit; the interest rate on the balance transfer sub-account (if any); the initiation fee for transferring the balance to the balance transfer sub-account (if any); the minimum payment on the balance transfer sub-account; conditions for modification of the balance transfer sub-account attributes; the pay-off date for the balance transfer sub-account; and the number of minimum payments necessary to pay off the balance transfer sub-account. Balance transfer sub-account record 156 may also store information regarding balance transfer transactions, such as: the amount of the customer's last payment; the date of the customer's last payment; the original amount of the transferred balance; the amount of the transferred balance remaining; and the balance limit currently available to the customer. Balance transfer sub-account record may also store information regarding the transferred balance, such as the original holder of the debt, the type of debt (e.g., credit card balance, auto loan, etc.) and the attributes originally applied to the balance (e.g., the interest rate, fees, minimum periodic payment, and pay-off date).

Account payment record 156 stores information concerning payments made to the issuer by the customer. This information may include information indicating how a payment is to be allocated between the credit line sub-account balance (from credit line account record 152) and the balance transfer sub-account balance (from balance transfer account record 154).

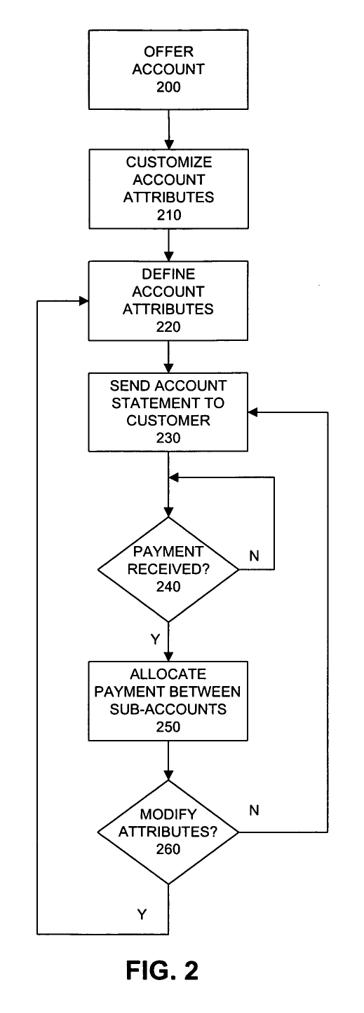

FIG. 2 illustrates exemplary methods for providing and managing financial accounts consistent with the present invention. While exemplary methods of the present invention are described as a series of acts, the order of the acts may vary in other implementations consistent with the present invention. In particular, non-dependent acts may be performed in any order, or in parallel.

At 200, an issuer offers an account having attributes consistent with the present invention to a potential customer. Offering the account may involve identifying a potential customer; customizing the terms and attributes of the account for the potential customer, and communicating the attributes of the account to the potential customer.

Identifying a potential customer may be done in a number of ways. A potential customer may be identified based on some customer characteristic believed to indicate that the customer would be sufficiently likely to respond to an offer of an account consistent with the present invention. For example, a customer who is identified as having a conventional loan outstanding or as having outstanding credit card debt may be sufficiently likely to respond. Further, a customer who may have an unrealized need for a new loan, such as a home improvement loan (e.g., identified as having recently purchased a home), an auto loan (e.g., identified as having recently visited an auto showroom or website), a student loan (e.g., identified as having recently been accepted to an institute of higher learning), a debt consolidation loan (e.g., identified as having outstanding delinquent debt, whether with the issuer or another lender), or other loan, may be sufficiently likely to respond. Alternatively, the customer may identify themselves by contacting the issuer, e.g., in response to an earlier offer or advertisement.

After a potential customer is identified, the attributes of the offered account may be communicated to the potential customer in a number of ways, e.g., via electronic mail, regular mail, an Internet web page, telephone, or media advertisement. The attributes of the offered account may be customized for the particular customer (210) either before or after the initial offer is communicated to the customer, and presented to the customer in a customized offer.

In exemplary embodiments consistent with the present invention, the attributes of the credit line sub-account are distinct from the attributes of the balance transfer sub-account, thus allowing the issuer flexibility to meet a particular customer's needs with respect to both types of accounts. The attributes of the balance transfer sub-account may include, but are not limited to: the balance limit; the interest rate on the balance transfer sub-account (if any); the initiation fee for transferring the balance to the balance transfer sub-account (if any); the minimum payment on the balance transfer sub-account; conditions for modification of the balance transfer sub-account attributes; the pay-off date for the balance transfer sub-account; and the number minimum payments necessary to pay off the balance transfer sub-account. The attributes of the credit line sub-account may include, but are not limited to: the credit limit; the grace period on purchases; minimum credit line purchase requirements; the interest rate on the credit line sub-account; the minimum payment on the credit line sub-account; conditions for modification of the credit-line sub-account attributes; and conditions for rewards to encourage purchases using the credit line sub-account.

Minimum purchase requirements refer to a number or value of purchases that the issuer may require the customer to make using the credit line sub-account in order to maintain the account in good standing. The issuer may use such a device to encourage purchases using the credit line sub-account; however, in exemplary embodiments consistent with the present invention, there are no minimum purchase requirements.

In an exemplary embodiment of the invention, system 100 may be used to customize the attributes of the offered account for a particular customer. For example, input module 120 may be used to gather identifying information about a particular customer as well as information concerning the particular customer's credit history and the particular customer's existing loans and outstanding balances. This information may be available from the customer or from another source, such as a financial database or one of the customer's existing creditors. Computing platform 110 may use the customer's identifying information and credit history to determine a credit rating for the customer using known methods. This information may be entered in customer account record 150.

Computing platform 110 may use the customer's credit rating to determine a credit limit for the credit line sub-account, which may then be entered in credit line sub-account record 152. Computing platform 110 may also use the customer's credit rating to determine a balance limit for a balance transfer sub-account, which may then be entered in balance transfer sub-account record 154. The balance limit may be distinct from the credit limit. Alternatively, the balance limit and the credit limit may each refer to an overall account limit, so that the customer has access to a total amount of credit that they may effectively allocate to each sub-account via their transactions.

In an exemplary embodiment consistent with the invention, customizing the account attributes at 210 includes determining a pay-off date by which the customer desires or agrees to pay off the transferred balance. The pay-off date may be chosen based upon the customer's long term financial plans. For example, the customer may wish to pay off a balance transferred from a conventional car loan before her child enters college.

The pay-off date may be determined unilaterally by the customer. Alternatively, the pay-off date may be determined by the customer in consultation with a customer service representative of the issuer or with the aid of a computer program, such as a web page maintained by the issuer. In either case, the customer may communicate their choice of pay-off date to the issuer in a number of ways, e.g., via electronic mail, regular mail, an Internet web page, or telephone. For instance, a field for the customer to specify the pay-off date may be provided on a return postcard accompanying a mailed solicitation or on a web page provided for the customer's response. As another alternative, the issuer's offer to establish an account for a certain customer may be conditioned on the customer's acceptance of a certain pay-off date, e.g., where the balance transfer sub-account is opened for the purposes of debt consolidation or reaffirmation.

Given the pay-off date, the amount of the transferred balance, the payment period, and the interest rate (if any) to be charged on the balance transfer sub-account, computing platform 110 may determine a periodic payment amount necessary to pay off the balance principal with interest by the desired pay-off date. Alternatively, the customer may determine a maximum periodic payment that they are willing to devote toward paying off the transferred balance; or the issuer may determine a minimum periodic payment that they are willing to accept from a given customer or class of customers (e.g., where interest is to be charged on the balance transfer sub-account, the issuer may require that the payment must be at least equal to the interest). Given the desired periodic payment amount, the amount of the transferred balance, the payment period, and the interest rate (if any) to be charged on the balance transfer sub-account, the date on which the transferred balance would be paid off can be determined, if desired, using known methods.

In either of these case, the periodic payment amount may be used as the minimum payment for the balance transfer sub-account, so that the customer is required to remit at least this periodic payment amount for each period. In an exemplary embodiment of the invention, an issuer may initially offer a minimum payment that is a percentage of the current balance in the balance transfer sub-account (e.g., 3%). A minimum payment that is structured in this manner will decrease as the balance is paid down.

In another exemplary embodiment of the invention, the issuer may initially offer a minimum payment that is a fixed amount of currency. For example, the issuer may offer a minimum payment that is a fixed amount, e.g., $100, regardless of the amount of the transferred balance. Alternatively, the issuer may offer a minimum payment that is a fixed amount that is based on the size of the transferred balance and/or the pay-off date. For example, as discussed above, the fixed amount may be the minimum periodic payment necessary to meet the pay-off date. A payment structured as a fixed amount of currency does not decrease as the balance is paid down. Consequently, a greater proportion of later payments goes toward the balance principal, thus further reassuring the customer that the balance will not become a static debt.

The minimum payment may be fixed as the maximum periodic payment that will be required on the balance transfer sub-account for a predetermined time period, such as for the life of the account or for the life of the transferred balance. By allowing the customer to customize a pay-off date and/or maximum periodic payment as a condition on the balance transfer sub-account, systems and methods consistent with the present invention provide an incentive for the customer to pay off the transferred balance according to their desired schedule and further reassure the customer that the transferred balance will not become a static debt.

The customized offer may include a comparison of the attributes of one or more of the particular customer's existing loans with the attributes of the offered account. Information on the attributes of the particular customer's existing loans may be available from the customer, e.g., in response to a prior solicitation, or from the existing creditor. The customized offer may include a side by side comparison of, e.g., the interest rate, monthly payment, number of required payments, and pay off date of the customer's existing loan with the interest rate, monthly payment, number of required payments, and pay off date available if the potential customer would transfer the balance of the existing loan to the offered balance transfer sub-account.

The customized offer may further include a statement of the amount of money the potential customer would save if they transferred the balance of the existing loan to the offered balance transfer sub-account. If the attributes of the existing loan are known, computing platform 110 may calculate these savings by determining the interest and fees that will be due on the existing loan and subtracting the interest and/or fees that would be paid on the transferred balance.

The terms and attributes of the customized offer may be communicated to the potential customer in a number of ways, e.g., via electronic mail, regular mail, an Internet web page, or telephone. Once the potential customer accepts the offer, the account may be opened and the terms may be memorialized in an account agreement that will govern the attributes of the account.

The balance transfer sub-account may be opened by transferring the balance of an existing debt which the customer owes to the issuer or to another financial institution, such as a conventional lender. For instance, the balance on an installment loan (e.g., an auto loan, student loan, home improvement loan, or debt consolidation loan, etc.) may be transferred to the issuer. The transfer may be effected by the issuer obtaining identifying information regarding the outstanding debt (e.g., the original debt-holder, the account identifier, and the amount of the debt) and paying off the original debt-holder or otherwise assuming obligation for the debt. Alternatively, the balance transfer sub-account may be opened by the customer incurring a new debt to the issuer, e.g., by the issuer distributing a check directly to the customer.

The customer may be provided with an access key for making purchases using the credit line sub-account. Examples of such access keys include: credit cards, fobs, biometric access procedures, or simply account identification numbers, or passwords. The customer may further be provided with a draft mechanism, such as a checkbook, for transferring additional balances to the balance transfer sub-account, up to the balance limit. As the customer pays down the balance on the balance transfer sub-account, they thereby add to the amount of funds available from their balance transfer sub-account using this draft mechanism.

At 220, the account attributes are defined, consistent with the account agreement. These attributes may be defined by making appropriate entries in records 150, 152, 154 and 156.

System 100 may then enter a period of billing cycles. A billing cycle may occur monthly, as is conventional, but may also occur as determined by the system 100. At 230, a statement is sent to the customer at the end of a billing cycle. The statement may include a conventional paper-based statement, mailed to the customer before the due date of the payment. Alternatively, the statement may be Internet-based, e.g., made available on a website or sent to the customer via e-mail. In any case, the statement may include information such as: the due date of the payment; the total minimum payment due; the minimum payment for each of the credit line and balance transfer sub-accounts; information (e.g., vendor, amount, date of purchase, and/or time of purchase) for the transactions made using the respective credit line and balance transfer sub-accounts; the respective balances of the credit line and balance transfer accounts; the total amount of available credit; the amount of additional balance or credit available in each of the credit line and balance transfer sub-accounts (if distinct limits are applied to the sub-accounts); the number of payments remaining on the transferred balance; the pay-off date for the balance transfer sub-account; and other information that may assist the customer.

In an exemplary embodiment of the invention, the statement may include a statement of the amount of money (if any), which the customer has saved by transferring the balance of a previous loan to the balance transfer sub-account. Computing platform 110 may calculate these savings by determining the interest and fees that would have been due to the original debt-holder and subtracting the interest and/or fees paid on the transferred balance. The savings may be calculated over a single billing period or over another period, e.g., over the previous twelve months, over the life of the balance, or over the life of the account.

After providing the customer with a billing statement, system 100 awaits receipt of payment from the customer (240). Once system 100 determines that payment has been received, computing platform 110 applies the payment toward the interest and/or fees (e.g., penalty fees or finance charges) due on the account (if any). Computing platform then accesses account payment record 156 to determine how to allocate any remaining payment between the credit line and balance transfer sub-accounts (250).

In an exemplary embodiment of the present invention, computing platform first applies the payment to meet the minimum payment on the balance transfer sub-account. Placing the balance transfer sub-account first in the payment hierarchy in this manner further reassures customers that the transferred balance will not become a static debt, and thus further encourages the transfer of larger balances to the issuer's accounts. If computing platform 110 determines that there is a balance in the credit line sub-account record 152, computing platform 110 then applies the payment to meet minimum payment on the credit line sub-account balance. If a balance remains in either of the credit line or balance transfer sub-accounts, any remaining payment may be divided between the credit line and balance transfer sub-account balances, e.g., in proportion to their respective contributions to the total account balance.

Alternatively, any remaining payment may be allocated to one or both sub-accounts in a predetermined manner based on the account attributes. For example, regardless of the balances in the sub-account records, computing platform 110 may allocate the remaining payment between the accounts according to a predetermined proportion, or solely to one or the other of the sub-account balances. As another alternative, the remaining payment may be allocated in a manner indicated by the customer with the individual payment, e.g., on a form accompanying the payment.

At 260, system 100 determines whether any of the account attributes are to be modified. The conditions for modification of the sub-account attributes may allow the issuer to unilaterally modify one or more of the attributes at will. For instance, the issuer may have the power to unilaterally modify (i.e., reprice) the interest rates on the credit line sub-account and/or the balance transfer sub-account in accordance with market forces (market repricing). For example, the interest rate on the credit line sub-account may be indexed to a particular standard (such as a bond rate).

Alternatively, the conditions for modification of the sub-account attributes may allow the issuer to modify one or more of the attributes only if the customer fails to meet one or more conditions of the account agreement (e.g., a rule break). For instance, the issuer may have the power to raise the interest rates on the credit line sub-account and/or the balance transfer sub-account if, e.g., the customer fails to make a timely minimum payment.

As another alternative, the conditions for modification of the sub-account attributes may allow the issuer to modify one or more of the attributes only if the customer requests or otherwise consents. For instance, the issuer may allow the customer to advance the pay-off date for the balance transfer sub-account, thus increasing their minimum payment. As another example, the account agreement may provide that the interest rate and/or the minimum payment on the balance transfer sub-account will not be raised for the life of the balance, regardless of whether the customer fails to meet one or more conditions of the account agreement. Thus the minimum payment may be the maximum required payment for the life of the balance and the interest rate may be the maximum interest rate for the life of the balance.

If the system 100 determines that one or more account attributes are to be modified, computing platform returns to 220 in order to redefine the attribute(s) in the appropriate account records 150, 152, 154 and/or 156. The process then returns to 230.

Illustrative combinations of attributes for the credit line (CL) sub-account and balance transfer (BT) sub-account of a financial account consistent with the present invention are set forth in the following table:

| | | CL SUB-ACCOUNT | | | BT SUB-ACCOUNT | |
|---|---|---|---|---|---|---|
| | | MINIMUM | | | MINIMUM | |
| | APR | PAYMENT | REPRICING | APR | PAYMENT | REPRICING |
| A | 3.99% | 5% of CL | standard | 3.99% | 3% of BT | none |
| | | balance | | | balance | |
| B | 3.99% | 2% | standard | 0.00, then | 2%, then 3% | none |
| | | | | 3.99% | | |
| C | 3.99% | 5% | standard | 3.99% | fixed ($100) | none |
| D | 6.9% | 3% | standard | 0.00% | 5% | only on rule |
| | | | | (2.5% fee) | | break |
| E | 6.9% | 3% | standard | 3.9% | Fixed (based | standard |
| | | | | | upon | |
| | | | | | selected pay- | |
| | | | | | off date) | |

It should be understood that the examples set forth in the above table are set forth only as an aid to understanding principles consistent with the present invention as set forth in the accompanying description, and should not be seen as limiting. In particular, the numerical percentages may change according to market forces, as is well known in the art.

In example A above, the interest rate on the credit line sub-account is subject to standard repricing: it may be repriced in accordance with market forces or if the customer fails to meet one or more conditions of the account agreement. However, the interest rate on the balance transfer sub-account may not be raised for the life of the account. Thus, even if the customer were to submit a late payment, their minimum payment would not rise. The minimum payment on the balance transfer sub-account fluctuates as a percentage (3%) of the balance in that sub-account, but this percentage may not be increased for the life of the account.

In example B, the interest rate on the balance-transfer sub-account is set at a lower introductory rate (0.00%) and then rises to a higher rate (3.99%) at a set time thereafter, e.g., in a 90 days “same-as-cash” offer; the minimum payment on the balance transfer sub-account is likewise set at a lower introductory rate (2%) and then rises to a higher minimum (3%) after the expiration of an introductory period, e.g., six months. However, the interest rate and minimum payment on the balance transfer sub-account are fixed at the time the account is opened. The interest rate may not be repriced and the minimum payment may not be increased, other than to the scheduled values at the scheduled times.

In example C, the minimum payment on the balance transfer sub-account is a fixed dollar amount ($100 in this example), regardless of the size of the transferred balance. Here, too, neither the minimum payment nor the interest rate on the balance transfer sub-account may be increased for the life of the account.

In example D, the interest rate on the balance transfer sub-account is 0.0% for the life of the balance. The issuer thereby forgoes interest income on the balance in the balance transfer sub-account, and instead charges an initiation fee. This initiation fee may be based on the size of the transferred balance. For instance, the initiation fee may be a predetermined percent (e.g., 2.5%) of the transferred balance. The initiation fee may be the only fee that will be charged on the transferred balance (absent a rule break). Because this fee income is generated at the opening of the account, it is not affected if the customer were to pay down the balance earlier than anticipated. However, this fee income may be less than the potential interest income over the life of a balance. Accordingly, the account in Example D has a relatively high minimum payment (5%).

In example E, the minimum payment on the balance transfer sub-account is a fixed amount that is calculated to allow the customer to pay off the transferred balance by the chosen pay-off date. In this example, both the credit line sub-account and the balance transfer sub-account are subject to standard repricing.

In either of these Examples A-E, the attributes for the balance transfer sub-account may be limited to balances transferred at the opening of the account or within a time period designated by the issuer. Alternatively, the attributes may apply for as long as the account remains open and/or in good standing.

It will be apparent to those skilled in the art that various modifications and variations can be made to the invention without departing from the scope or spirit of the invention.

Other modifications and embodiments of the invention will be apparent to those skilled in the art from consideration of the specification and practice of the invention disclosed herein. Therefore, it is intended that the specification and examples be considered as exemplary only, with a true scope and spirit of the invention being indicated by the following claims.

1. A method for managing a financial account, comprising:
creating a financial account for a customer, the financial account comprising:
a credit line sub-account for managing purchases by the customer; and
a balance transfer sub-account for managing at least one balance transferred by the customer; and
defining attributes for the balance transfer sub-account, the attributes comprising a maximum required periodic payment and a maximum interest rate that are fixed for the life of the balance.

2. The method of claim 1, wherein the maximum required periodic payment is defined as a fixed amount.

3. The method of claim 1, wherein the maximum interest rate is defined as 0% and the method further comprises defining, for the balance transfer sub-account, an account initiation fee.

4. The method of claim 3, wherein the account initiation fee is based upon the size of the transferred balance.

5. The method of claim 1, wherein defining attributes for the balance transfer sub-account further comprises defining a pay-off date for the balance transfer sub-account.

6. The method of claim 5, wherein defining a pay-off date for the balance transfer sub-account comprises receiving a desired pay-off date from the customer.

7. The method of claim 1, wherein the balance transferred by the customer is a payment made to the customer by an issuer of the financial account at the time the financial account is opened.

8. The method of claim 1, wherein the financial account is a credit card account.

9. A method for managing a financial account, comprising:
creating a financial account for a customer, the financial account comprising:
a credit line sub-account for managing purchases by the customer; and
a balance transfer sub-account for managing at least one balance transferred by the customer; and
customizing a pay-off date for the balance transferred to the balance transfer sub-account.

10. The method of claim 9, wherein customizing a pay-off date comprises receiving a desired pay-off date from the customer.

11. The method of claim 9, further comprising defining attributes for the balance transfer sub-account, the attributes comprising a maximum required periodic payment and a maximum interest rate that are fixed for the life of the balance.

12. The method of claim 11, wherein the maximum required periodic payment is defined as a fixed amount.

13. The method of claim 11, wherein the maximum interest rate is defined as 0% and the method further comprises defining, for the balance transfer sub-account, an account initiation fee.

14. The method of claim 9, wherein the financial account is a credit card account.

15. A method for managing a financial account, comprising:
creating a financial account for a customer, the financial account comprising:
a credit line sub-account for managing purchases by the customer; and
a balance transfer sub-account for managing at least one balance transferred by the customer; and
defining attributes for the balance transfer sub-account, the attributes comprising:
an interest rate of 0% for the life of the balance, and a balance transfer fee that is based upon the size of the at least one transferred balance.

16. The method of claim 15, further comprising providing the customer with a draft mechanism for transferring an additional balance to the balance transfer sub-account, up to a predetermined limit.

17. The method of claim 15, further comprising applying a payment received from the customer toward a minimum periodic payment on the balance transfer sub-account before applying the payment toward a minimum periodic payment on the credit line sub-account.

18. A system for managing a financial account, comprising:
means for creating a financial account for a customer, the financial account comprising a credit line sub-account for managing purchases by a customer and a balance transfer sub-account for managing at least one balance transferred by the customer; and
means for defining attributes for the balance transfer sub-account, the attributes comprising a maximum required periodic payment and a maximum interest rate that are fixed for the life of the balance.

19. The system of claim 18, wherein the means for creating a financial account comprises means for creating credit card account.

20. A system for managing a financial account, comprising:
means for creating a financial account for a customer, the financial account comprising a credit line sub-account for managing purchases by a customer and a balance transfer sub-account for managing at least one balance transferred by the customer; and
means for customizing a pay-off date for the balance transferred to the balance transfer sub-account.

21. The system of claim 20, wherein the means for customizing a pay-off date comprises means for receiving a desired pay-off date from the customer.

22. The system of claim 20, further comprising means for defining attributes for the balance transfer sub-account, the attributes comprising a maximum required periodic payment and a maximum interest rate that are fixed for the life of the balance.

23. The system of claim 22, wherein the maximum required periodic payment is defined as a fixed amount.

24. The system of claim 22, wherein the maximum interest rate is defined as 0% and the system further comprises means for defining an account initiation fee for the balance transfer sub-account.

25. The system of claim 20 wherein the means for creating a financial account comprises means for creating a credit card account.

26. A system for managing a financial account, comprising:
means for creating a financial account for a customer, the financial account comprising a credit line sub-account for managing purchases by a customer and a balance transfer sub-account for managing at least one balance transferred by the customer; and
means for defining attributes for the balance transfer sub-account, the attributes comprising: an interest rate of 0% for the life of the account, and a balance transfer fee that is based upon the size of the at least one transferred balance.

27. The system of claim 26, further comprising means for providing the customer with a draft mechanism for transferring an additional balance to the balance transfer sub-account, up to a predetermined limit.

28. The system of claim 26, further comprising means for applying a payment received from the customer toward a minimum periodic payment on the balance transfer sub-account before applying the payment toward a minimum periodic payment on the credit line sub-account.

29. A computer readable medium capable of configuring a computing platform to perform a method for managing a financial account, the method comprising:
creating a financial account for a customer, the financial account comprising:
a credit line sub-account for managing purchases by the customer; and
a balance transfer sub-account for managing at least one balance transferred by the customer; and
defining attributes for the balance transfer sub-account, the attributes comprising a maximum required periodic payment and a maximum interest rate that are fixed for the life of the balance.

30. The computer readable medium of claim 29, wherein the maximum required periodic payment is defined as a fixed amount.

31. The computer readable medium of claim 29, wherein the maximum interest rate is defined as 0% and the method further comprises defining, for the balance transfer sub-account, an account initiation fee.

32. The computer readable medium of claim 31, wherein the account initiation fee is based upon the size of the transferred balance.

33. The computer readable medium of claim 29, wherein defining attributes for the balance transfer sub-account further comprises defining a pay-off date for the balance transfer sub-account.

34. The computer readable medium of claim 33, wherein defining a pay-off date for the balance transfer sub-account comprises receiving a desired pay-off date from the customer.

35. The computer readable medium of claim 29, wherein the balance transferred by the customer is a payment made to the customer by an issuer of the financial account at the time the financial account is opened.

36. The computer readable medium of claim 29, wherein the financial account is a credit card account.

37. A computer readable medium capable of configuring a computing platform to perform a method for managing a financial account, the method comprising:
creating a financial account for a customer, the financial account comprising:
a credit line sub-account for managing purchases by the customer; and
a balance transfer sub-account for managing at least one balance transferred by the customer; and
customizing a pay-off date for the balance transferred to the balance transfer sub-account.

38. The computer readable medium of claim 37, wherein customizing a pay-off date comprises receiving a desired pay-off date from the customer.

39. The computer readable medium of claim 37, wherein the method further comprises defining attributes for the balance transfer sub-account, the attributes comprising a maximum required periodic payment and a maximum interest rate that are fixed for the life of the balance.

40. The computer readable medium of claim 39, wherein the maximum required periodic payment is defined as a fixed amount.

41. The computer readable medium of claim 39, wherein the maximum interest rate is defined as 0% and the method further comprises defining, for the balance transfer sub-account, an account initiation fee.

42. The computer readable medium of claim 37, wherein the financial account is a credit card account.

43. A computer readable medium capable of configuring a computing platform to perform a method for managing a financial account, comprising:
creating a financial account for a customer, the financial account comprising:
a credit line sub-account for managing purchases by the customer; and
a balance transfer sub-account for managing at least one balance transferred by the customer; and
defining attributes for the balance transfer sub-account, the attributes comprising: an interest rate of 0% for the life of the balance, and a balance transfer fee that is based upon the size of the at least one transferred balance.

44. The computer readable medium of claim 43, wherein the method further comprises providing the customer with a draft mechanism for transferring an additional balance to the balance transfer sub-account, up to a predetermined limit.

45. The computer readable medium of claim 43, wherein the method further comprises applying a payment received from the customer toward a minimum periodic payment on the balance transfer sub-account before applying the payment toward a minimum periodic payment on the credit line sub-account.
